(19) United States
(12) Patent Application Publication
(10) Pub. No.: US 2007/0190991 A1
(43) Pub. Date: Aug. 16, 2007

(54) Method for automatically restoring the default alert setting of a cellular telephone

(76) Inventor: Frances Johnson Cargille, New Orleans, LA (US)

Correspondence Address: Steven M. Crosby, 5 Northfield Avenue, East Brunswick, NJ, 08816, US

(21) Appl. No.: 11/352,544

(22) Filed: Feb. 11, 2006

(51) Int. Cl. H04M 3/42

(52) U.S. Cl. 455/415; 455/567

(57) ABSTRACT

The invention provides a method for temporarily changing an alert type of a cell phone to a desired alternative alert type and restoring the alert type after the expiration of a time interval established by the user of the cell phone. The method comprises the steps of: receiving user input identifying the desired alternative alert type; receiving user input identifying a desired alternative alert time interval; activating the desired alternative alert type; and restoring the initial alert type after expiration of the desired time interval. The method may further include the step of displaying a list of the available alternative alert types from which the user may choose in identifying the alternative alert type. The invention further provides a cell phone capable of implementing the method described above.

### FIELD OF INVENTION

The present invention relates to the field of mobile cellular telephone technology.

### BACKGROUND OF THE INVENTION

Modern cellular telephone devices (“cellular telephones” or “cell phones”) often need to inform users of various real-time events. Examples of such events include an incoming telephone call, text message, page, caller ID number or timer alarm. Traditionally, these devices use audible signaling to alert the user that some action is required to service the event.

However, many cell phones also have a menu-selected “silent” feature, to minimize the risk of disturbing others, that switches alerts from an audible signal to an alternative alert mode that could include a vibration alert and/or a visual alert, such as a flashing light emitting diode (LED). In response to the alternative alert, the user can decide to take action, such as answer the call, return the page or respond to a text message, or the user can choose to respond to the alternative alert at a later time, further minimizing the risk of disturbing others. Such a silent feature is valuable in certain business and social settings where audible signaling would disturb others in the immediate vicinity of the cell phone, including settings such as meetings, restaurants, theaters, courtrooms, churches, temples and mosques.

A difficulty arises when the user is in a quiet setting or meeting environment where an audible alert from a cell phone would be inappropriate. In such locations, signs are often posted requesting that patrons either turn off their cell phones, or switch them to silent mode. However, there is no way to ensure that the user of such cell phone will remember to switch the cell phone back to an audible alert after the user has left the quiet setting or meeting. Finally, the user may miss a time-sensitive call by forgetting to turn the cell phone back on after leaving the quiet setting or meeting location. Moreover, if the alternative alert mode is set to vibrate (or some other non-audible alert mode), but the cell phone is no longer being carried or in close enough proximity to the user's body or field of vision to be effective as an alert, the user is likely to miss calls.

Therefore, a need exists for a method and cell phone that allows the user to select an alternative alert type and time interval for the duration of time that the user plans to be in the quiet setting or meeting environment. During such a time interval, such a method and cell phone should not disturb those around the user of the cell phone. Further, at the end of the time interval, the cell phone should restore the previous audible alert type.

### BRIEF SUMMARY OF THE INVENTION

The above problems can be overcome, and advance made in the art, by providing a method and cell phone that automatically restores the previous audible alert type after a user-determined time interval for the alternative alert type expires. By restoring the audible alert mode automatically, the user can avoid missed calls.

In particular, the present invention provides a method for temporarily changing the alert type of a cell phone from an initial alert type to a desired alternative alert type. The method comprises the steps of: receiving user input identifying the desired alternative alert type; receiving user input identifying a desired alternative alert time interval; activating the desired alternative alert type; and restoring the initial alert type after expiration of the desired time interval. The method may further include the step of displaying a list of the available alternative alert types from which the user may choose in identifying the alternative alert type.

The method also provides at least two ways for a user to identify and select the desired alternative alert time interval. The first way is to display a list of the available alternative alert time interval presets from which the user may choose in identifying the desired alternative alert time interval and prompt the user to select from the list. The second way is to prompt the user to identify a period of time for the desired alternative alert time interval without the use of presets. In particular, the user input identifying the desired alternative alert time interval may be a quantity of at least one of hours and minutes. Alternatively, the user input may be a user-defined time representing the desired end time of the desired alternative alert time interval (e.g., a time certain, such as 7:30 p.m.).

Further, the invention contemplates two alternatives for restoring the desired initial alert type after expiration of the desired time interval. In one alternative, the method includes setting a timer to the desired alternative alert time interval and decrementing the timer. In another alternative, applicable where the user input is a user defined time representing the desired end time, the method includes the step of comparing the current time with the user defined time to determine if the desired time interval has expired.

The invention further provides a cell phone capable of changing an alert type from an initial alert type to an alternative alert type. The cell phone comprises: a processor; one or more alert devices; a memory connected to the processor; an interface connected to the processor; and a display connected to the processor. In accordance with the invention, the memory includes a set of instructions that, when executed, cause the processor to perform the method described above.

### BRIEF DESCRIPTION OF THE DRAWINGS

FIG. 1. is a block diagram of a cell phone in accordance with an exemplary embodiment of the present invention.

FIG. 2. is a flowchart illustrating the method for temporarily changing the alert type of a cell phone from an initial alert type to a desired alternative alert type and restoring the initial alert time after a predetermined time in accordance with the present invention.

### DETAILED DESCRIPTION OF THE INVENTION

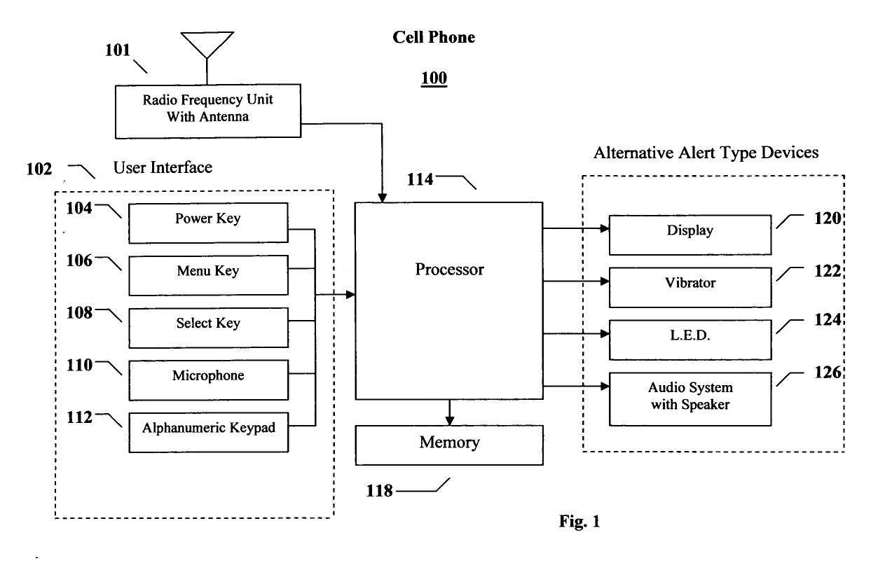

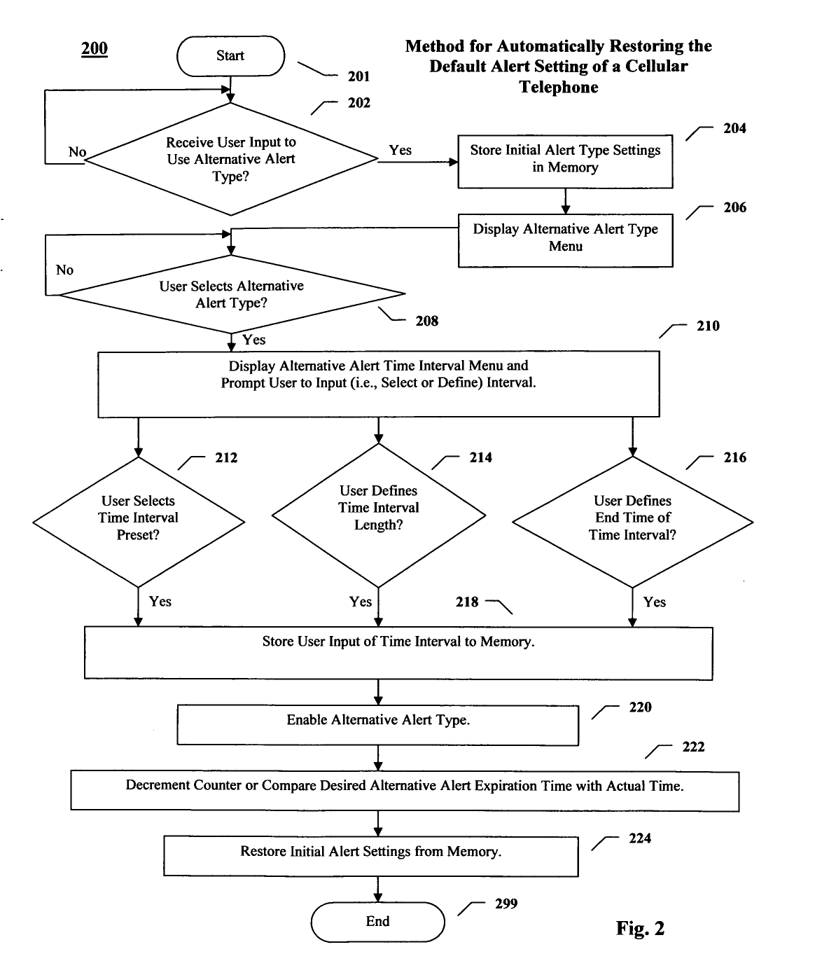

The present invention can be better understood with reference to FIGS. 1 and 2. FIG. 1 is a view illustrating a block diagram of a cell phone 100 in accordance with the preferred embodiment of the present invention. But it should also be understood that the scope of this invention also applies to other mobile electronic and wireless communications devices, such as pagers.

Referring to FIG. 1, the cell phone 100 includes a radio frequency unit 101 with an antenna to support a radio link to a wireless communications network infrastructure. The cell phone 100 receives input from a user of the cell phone (“user input”) via a number of cell phone interfaces 102, including function keys (e.g., power key 104, menu key 106, and select key 108), a microphone 110 to receive audio input, and an alphanumeric keypad 112 to receive alphanumeric user input. The features of cell phone 100 are described in more detail below.

Alphanumeric keypad 112, power key 104, menu key 106, and select key 108 accept input via depression of an individual key. Microphone 110 accepts input by receiving an audible response from a user of cell phone 100. Such audible input can be processed by processor 114 using a speech-to-text converter, voice recognition processing, or other methods of utilizing speech for input. The power key 104 is used to toggle the cell phone between active and standby mode. Menu key 106 is used to invoke various menus on display 120 to configure and control the operation of the cell phone 100. Select key 108 is used to choose various options from menus displayed on display 120.

The cell phone 100 also includes a processor 114 to control an overall operation of the cell phone and to process user input and generate output, a memory 116, a display 120 and one or more of a plurality of alternative alert types hardware 118 (specifically, the display 120, a vibrating actuator 122, a light emitting diode 124 (“LED”), and an audio output system 126).

In operation, the user enables the cell phone 100 by depressing power key 104. Various setup and configuration commands are entered using menu key 106 and select key 108 while observing the prompts on the display 120. Numeric inputs, such as dialed numbers, are entered on the alphanumeric keypad 112. Once a call is originated, the user speaks into microphone 110 and listens through speaker 126. Radio frequency unit with antenna 101, in conjunction with circuitry internal to cell phone 100, such as radio frequency transmitters and receivers, amplifiers, processors, interfaces and digital signal processors (not shown), provides a radio interface to base stations and mobile communications networks (also not shown). Memory 116 provides data storage for the set of instructions (or program) that the processor 114 executes during operation, and further for various other information needed by processor 114.

FIG. 2 depicts a flow chart 200 of a feature available to the user to store in memory the current alert type settings (“initial settings”), control the specification and activation of alternative alert type hardware configurations, and specify a time interval for the alternative alert type to run before the initial settings are automatically restored. Starting at 201, the processor 114 waits in loop 202 for user input indicating that the user wishes the initial (i.e., then-current) alert type to be replaced by an alternative alert type. When such a request is detected, processor 114 stores the initial settings in memory in block 204, displays a list of available alternative alert types on the display 120 in block 206, and prompts the user to select an alternative alert type from the list. Such alternative alert types may include, but are not limited to, a vibration alert type, a visual alert type, an alternate display alert type, or an alternate audible alert type.

The processor 114 then waits in loop 208 for the user to specify the desired alternative alert type. The user may input the alternative alert type by inputting on the interface. Where only a single alternative alert type is available (e.g., a vibration alert type) the user may specify the vibration alert type by pressing a single button (e.g., pressing and holding one of the function keys on the cell phone). After the user specifies the desired alternative alert type, processor 114 displays the alternative alert time interval menu on the display 120 in block 210. This menu includes selectable presets and definable fields. The selectable presets displayed on display 120 in block 210 provide the user with a list of the available preset time interval options from which to choose, with possible preset values of, e.g., 30 minutes, 60 minutes, 90 minutes and 120 minutes.

The definable fields in the alternative alert time interval menu provide the user with two options for inputting the alternative alert time interval value through the alphanumeric keypad input, either by specifying a time interval length in units of hours and/or minutes or by specifying a time of day representing the end time of the interval. Two definable fields are available for input in the menu. One definable field prompts the user to input the desired time interval in units of hours and minutes. The other definable field permits the user to input the desired time of day that the time interval is to expire, in hours and minutes and to indicate either “a.m.” or “p.m.”

The alternative alert time interval menu preferably also includes prompts, which provide the user with a sense of orientation and instructions for navigating through the alternate alert time interval specification process in block 210. The instructions direct the user to either select a preset time interval value from the list of interval presets or to specify a value in one or more of the user-definable fields described above.

The processor 114 then waits in loop 212 for the user to specify the alternative alert time interval. Once a user chooses the alternative alert time interval option and inputs the desired alternative alert time interval, the alternative alert type is enabled in block 222 for the duration of the alternative alert time interval. The expiration of the alternative alert time interval may be determined in various ways. For example, where the user has specified an end time for the alternative alert time interval, the processor 114 may compare the current time with the user-defined end time to determine if the desired time interval has expired. Alternatively, where the user has specified a quantity for the alternative alert time interval, the processor 114 may set a timer to the desired alternative alert time interval and decrement the timer until the alternative alert time interval expires. After the alternative alert time interval expires, the cell phone automatically restores the initial alert type settings in block 224 and the sequence of steps ends in block 299.

There has thus been described a method and cell phone that automatically restores the previous audible alert type after a user-determined time interval for the alternative alert type expires. While this invention has been described in terms of certain examples, however, it is not intended to be limited to the above description, but rather only to the extent set forth in the claims that follow.

What is claimed is:

1. A method for temporarily changing the alert type of a cellular telephone from an initial alert type to a desired alternative alert type, comprising the steps of:
receiving user input identifying the desired alternative alert type;
receiving user input identifying a desired alternative alert time interval;
activating the desired alternative alert type; and
restoring the initial alert type after expiration of the desired alternative alert time interval.

2. The method of claim 1, further comprising the step of displaying a list of the available alternative alert types from which the user may choose in identifying the desired alternative alert type.

3. The method of claim 1, further comprising the step of displaying a list of the available alternative alert time interval presets from which the user may choose in identifying the desired alternative alert time interval.

4. The method of claim 3, further comprising prompting the user to select from the list of available alternative alert time interval presets.

5. The method of claim 1, further comprising the step of prompting the user to identify a period of time for the desired alternative alert time interval without the use of presets.

6. The method of claim 5, wherein the user input identifying the desired alternative alert time interval is a quantity of at least one of hours and minutes.

7. The method of claim 5, wherein the user input identifying the desired alternative alert time interval is a user-defined time representing the end time of the desired alternative alert time interval.

8. The method of claim 7, further comprising the step of comparing the current time with the user-defined time to determine whether the desired alternative alert time interval has expired.

9. The method of claim 1, further comprising the steps of:
setting a timer to the desired alternative alert time interval; and
decrementing the timer until the expiration of the desired alternative alert time interval.

10. A cellular telephone capable of changing an alert type from an initial alert type to an alternative alert type comprising:
a processor;
one or more alert devices;
a memory connected to the processor;
an interface connected to the processor;
a display connected to the processor;
wherein the memory includes a set of instructions that, when executed, cause the processor to perform the following steps:
i. receiving, through the interface, user input identifying the desired alternative alert type;
ii. receiving, through the interface, user input identifying a desired alternative alert time interval;
iii. activating the desired alternative alert type; and
iv. restoring the initial alert type after expiration of the desired alternative alert time interval.

11. The cellular telephone of claim 10, wherein the instructions further cause the processor to output, via the display, a list of available alert types through the display from which the user may choose in identifying the desired alternative alert type.

12. The cellular telephone of claim 10, wherein the instructions further cause the processor to output, via the display, a list of alternative alert time interval presets from which the user may choose in identifying the period of time for the desired alternative alert time interval.

13. The cellular telephone of claim 12, wherein the user input identifying the desired alternative alert time interval is selected from the list of available alternative alert time interval presets.

14. The cellular telephone of claim 13, wherein the user input identifying the desired alternative alert time interval is a quantity of at least one of hours and minutes.

15. The cellular telephone of claim 13, wherein the user input identifying the desired alternative alert time interval is a time representing the end of the desired alternative alert time interval.

16. The cellular telephone of claim 13, wherein the instructions further cause the processor to store in memory the user-defined time representing the end of the desired alternative alert time interval and to compare the current time with the stored time to determine if the desired alternative alert time interval has expired.

17. The cellular telephone of claim 10, wherein the instructions further cause the processor to prompt the user, via the display, to identify the desired alternative alert time interval via the interface.

18. The cellular telephone of claim 10, wherein the instructions further cause the processor to store in memory the user-defined alternative alert time interval and to execute a set of timer decrementing instructions based on the stored time interval.
